(19) United States
(12) Patent Application Publication
(10) Pub. No.: US 2006/0293069 A1
(43) Pub. Date: Dec. 28, 2006

(54) Method and system for controlling an electronic device

(76) Inventors: Jayesh M. Patel, Mundelein, IL (US); Julie A. Cordua, Los Angeles, CA (US)

Correspondence Address: MOTOROLA INC, 600 NORTH US HIGHWAY 45, ROOM AS437, LIBERTYVILLE, IL, 60048-5343, US

(21) Appl. No.: 11/168,946

(22) Filed: Jun. 28, 2005

(51) Int. Cl. H04Q 7/20

(52) U.S. Cl. 455/466; 455/41.2

(57) ABSTRACT

A method and a system for controlling an electronic device (102) are provided. The method includes receiving a first control message from a network (110). After the first control message is received, a second control message is received from a local device. Further, an application corresponding to the second control message is executed. The application corresponding to the second control message is selected from one or more applications present in the electronic device.

### FIELD OF THE INVENTION

The present invention relates to the field of electronic devices. In particular, the present invention relates to controlling an electronic device.

### BACKGROUND OF THE INVENTION

Electronics devices, such as mobile phones, Personal Digital Assistants (PDAs), and laptops perform a wide variety of tasks and assist users in their daily activities. For example, these electronic devices can be used to access various services and information. These services and information include, but are not limited to, checking emails, browsing the Internet, sending messages, and Location Based Services (LBS). The LBS are those services that are provided to a user of the electronic device, when the user is present in a particular location. Some Examples of LBS may include, but are not limited to, an inquiry for a local railway time-table, and an inquiry about the location of different hotels and restaurants in the particular location.

There are various systems available for providing the LBS. One such system uses Radio Frequency Identification (RFID) tags for initiating and executing the LBS. The RFID tags may store information related to the LBS. The information stored in the RFID tag is transferred to the electronic device when the electronic device with an RFID reader is in proximity of the RFID tag. The electronic device, upon receiving the information, invokes a service related to information stored in the RFID tag. However, the above-mentioned system requires different RFID tags, to store information related to different services. The different RFID tags are service-specific and need to be replaced if a new service is to be associated with them.

### BRIEF DESCRIPTION OF THE DRAWINGS

The present invention is illustrated by way of example, and not limitation, in the accompanying figures, in which like references indicate similar elements, and in which:

FIG. 1 illustrates an exemplary electronic device, in accordance with various embodiments of the present invention.

FIG. 2 illustrates a flow diagram for controlling an electronic device, in accordance with an exemplary embodiment of the present invention.

FIG. 3 illustrates a flow diagram for controlling an electronic device, in accordance with another exemplary embodiment of the present invention.

FIG. 4 is a block diagram illustrating a lookup table, in accordance with various exemplary embodiments of the present invention.

FIG. 5 illustrates an exemplary existing look-up table and an exemplary modified look-up table, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements, to help to improve understanding of embodiments of the present invention.

### DETAILED DESCRIPTION

In accordance with one exemplary embodiment of the present invention, an electronic device is provided. The electronic device includes a Radio Frequency Identification (RFID) reader, a look-up table, an application selecting module, and one or more applications. The RFID reader reads RFID data from an RFID tag. The look-up table includes one or more mappings between RFID data and the one or more applications present in the electronic device. The look-up table may be modified by using a first control message received from a network. The application selecting module executes an application on the basis of the RFID data received by the RFID reader. Further, the application is selected from the one or more applications present in the electronic device by using the look-up table.

In accordance with another exemplary embodiment of the present invention, a method for controlling an electronic device is provided. The electronic device receives a first control message from a network. After receiving the first control message, a second control message is received by the electronic device from a local device. Further, an application corresponding to the second control message is executed. The application is selected from the one or more applications present in the mobile phone by using the first control message.

Before describing in detail the particular method and system for controlling an electronic device in accordance with the present invention, it should be observed that the present invention resides primarily in combinations of method steps and apparatus components related to method and system for controlling an electronic device. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising.

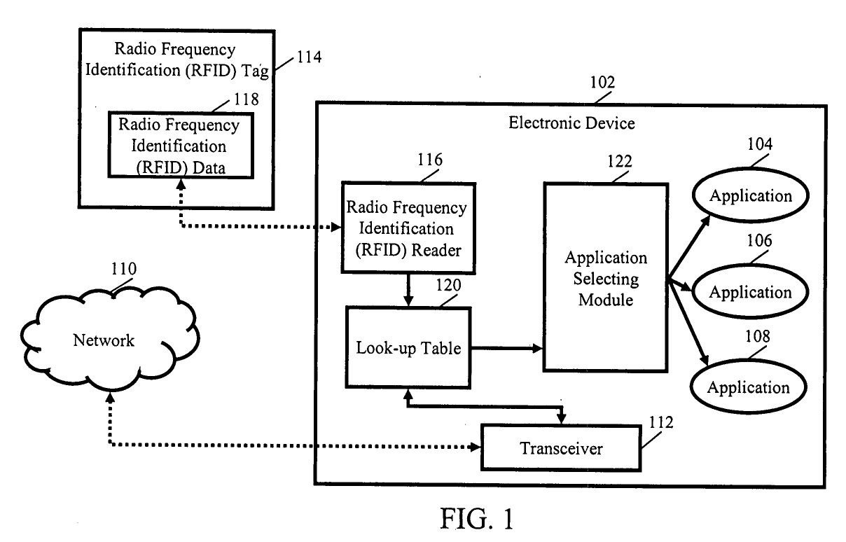

FIG. 1 illustrates an electronic device 102, in accordance with various embodiments of the present invention. The electronic device 102 includes one or more applications, for example, a first application 104, a second application 106, and a third application 108. Examples of the electronic device 102 include, but are not limited to RFID reader, a mobile phone, a laptop, and a Personal Digital Assistant (PDA).

The electronic device 102 receives a first control message from a network 110. Examples of the network 110 include, but are not limited to, a Local Area Network (LAN), a Wide Area Network (WAN), the Internet, and a cellular service network. In an embodiment of the present invention, a transceiver 112, present in the electronic device 102, receives the first control message. After the first control message is received, the electronic device 102 receives a second control message from a local device. Examples of the local device include, but are not limited to, a computer, a Personal Digital Assistant (PDA), a radiotelephone and an RFID tag 114.

Further, a suitable application corresponding to the second control message is executed. The suitable application is selected from the one or more applications on the basis of the first control message. Examples of the one or more applications include, but are not limited to, a Short Message Service (SMS) application, a Multimedia Message Service (MMS) application, an Enhanced Message Service (EMS) application, an Electronic mail (email) application, a Push-to-Talk (PTT) application, a telephony application, a web browsing application, and an electronic device configuration application.

In an embodiment of the present invention, an RFID reader 116, present in the electronic device 102, receives the second control message, for example, an RFID data 118 from the RFID tag 114, using RFID technology. RFID technology uses electromagnetic or electrostatic coupling in the Radio Frequency (RF) band of the electromagnetic spectrum. The RFID tags can store data, such as a unique ID, a phone number, a text document, a URL, data related to initiation/configuration of electronic device services, an electronic device application, a random number or any combination thereof. The RFID can function as a memory storing information a user desires. The RFID tags may be placed on objects such as merchandise, embedded in clothing, vehicles, jewelry for example.

The RFID tags may be placed for example at different geographical locations, such as, retail stores, restaurants, airports, and bus stops. The RFID tags placed at different locations may provide information pertaining to them. For example, RFID tags placed in a restaurant may provide the restaurant menu. Similarly, RFID tags placed in the bus stop may provide the arrival time of different buses arriving at the bus stop. In an embodiment of the present invention, the RFID tags may also include a graphical/visual representation associated with them, for example, a photograph and a text. The graphical/visual representation graphically/visually associates the RFID tags with their functionality. For example, if an RFID tag stores a phone number of a local hospital, then it may have a photograph of the local hospital or ‘Hospital’ written on it. Similarly, if an RFID tag stores information about a railway reservation, then it may have a photograph of an engine posted on it.

In another exemplary embodiment of the present invention, the RFID reader 116 passes the RFID data 118 to a look-up table 120 present in the electronic device 102. The look-up table 120 includes one or more mappings between the RFID data and the one or more applications. In an embodiment of the present invention, the look-up table 120 can include a mapping between the RFID data 118 and one of the applications 104, 106, and 108. The information related to mapping is then passed to an application selecting module 122. The application selecting module 122 selects and executes one of the applications 104, 106, and 108, based on the information related to mapping. For example, if the RFID data 118 is mapped to an SMS application, the information related to the mapping is passed on to the application selecting module 122. The information related to the mapping can include an application identifier that identifies the SMS application in the electronic device 102. Further, the application selecting module 122 can execute the SMS application, based on the application identifier.

The look-up table may not be located on the device and may be more centrally located for example the look-up table may be located on a server. The electronic device 102 may communicate with the server and send the RFID data received to the server. The server would search for information related to or associated with the RFID tag. The information associated with the RFID tag and stored on the server, or retrieved from elsewhere by the server, may then be sent to the electronic device 102 in one exemplary embodiment, or another function initiated in response to the RFID data 118. The server with the look-up table may execute an application either on the server itself, a device coupled to the server or another computer or device in communication with the server over a network such as the internet for example.

The look-up table 120 is also capable of being modified using the first control message. The modification in the look-up table 120 can include changing mappings between the RFID data and one or more applications present in the electronic device 102.

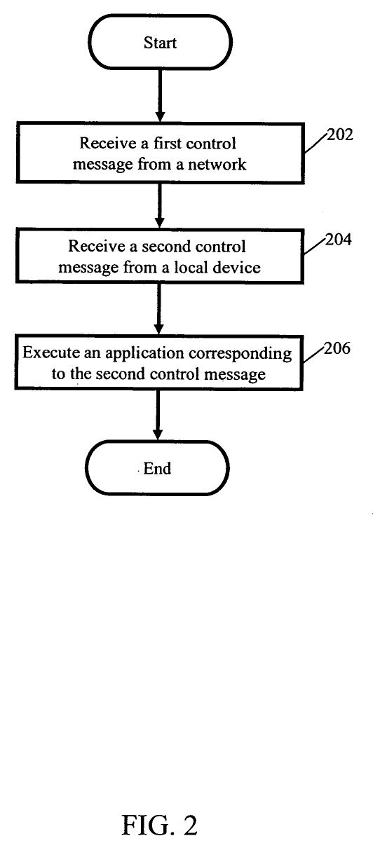

FIG. 2 illustrates a flow diagram for controlling the electronic device 102, in accordance with an embodiment of the present invention. At step 202, a first control message is received by the transceiver 112 from the network 110. In an exemplary embodiment of the present invention, the first control message can be received periodically. In another exemplary embodiment of the present invention, the first control message can be received when a user of the electronic device 102 changes location. The control message may be an impendent control message having a predetermined format or follow other protocols. For example the first control message may be sent as part of a Short Message Service (SMS) message, a Multimedia Message Service (MMS) message, an Enhanced Message Service (EMS) message, an Electronic mail (email) or the like. At step 204, a second control message is received by the electronic device 102 from a local device. Examples of the local device include, but are not limited to, an RFID tag, a laptop, a Personal Digital Assistant (PDA) or the like.

In an exemplary embodiment of the present invention, the second control message may be received from the local device over a local wireless link. In another exemplary embodiment of the present invention, the second control message can be received by the RFID reader 116 present in the electronic device 102. Examples of the second control message include, but are not limited to, a Short Message Service (SMS) message, a Multimedia Message Service (MMS) message, an Enhanced Message Service (EMS) message, an Electronic mail (email), and an RFID data. At step 206, an application corresponding to the second control message is executed. The application corresponding to the second control message can be executed by the application selecting module 122.

The application corresponding to the second control message can be selected from the one or more applications on the basis of the first control message. In an embodiment of the present invention, the application corresponding to the second control message is selected from applications 104, 106, and 108, on the basis of the first control message.

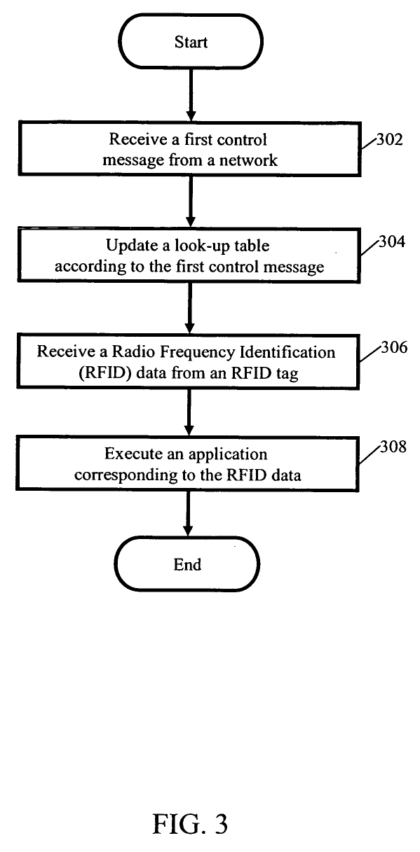

FIG. 3 illustrates a flow diagram for controlling the electronic device 102, in accordance with another exemplary embodiment of the present invention. At step 302, a first control message is received by the transceiver 112 from the network 110. In one exemplary embodiment of the present invention, the first control message can be received periodically. In another exemplary embodiment of the present invention, the first control message may be received in response to a location change of the electronic device 102. In yet another exemplary embodiment of the present invention, the user of the electronic device 102 may initiate a request for the first control message. In one exemplary embodiment the user may initiate a request for the first control message if the first control message is not received by the electronic device 102 In another exemplary embodiment the user may initiate a request for the first control message if there is an RFID tag that is not associated with an application present in the electronic device 102. In still yet another exemplary embodiment the user may initiate a request for the first control message if the first control message is not received by the electronic device 102 and there is an RFID tag that is not associated with an application present in the electronic device 102.

At step 304, the look-up table 120 is updated, based on the first control message. Examples of the look-up table 120 include, but are not limited to, a database, an array, a link list, and a hash table or the like. In one exemplary embodiment of the present invention, the look-up table 120 can be updated by adding an entry to the look-up table 120. In another embodiment of the present invention, the look-up table 120 can be updated by modifying an existing entry in the look-up table 120. The look-up table 120 includes one or more mappings between the RFID data and one or more applications. In one exemplary embodiment of the present invention, the look-up table 120 may include the mapping between the RFID data 118 and one of the applications 104, 106, and 108 present in the electronic device 102. At step 306, the RFID data is received by the RFID reader 116 from the RFID tag 114. At step 308, an application corresponding to the RFID data is executed. The application corresponding to the RFID data can be executed by the application selecting module 122. The application corresponding to the RFID data is selected from the one or more applications present in the electronic device 102. In an embodiment of the present invention, the application corresponding to the RFID data can be selected from one of the applications 104, 106 and 108.

In one exemplary embodiment of the present invention, the RFID tag 114 may be an electronic charm. An electronic charm is an object having the RFID tag carried thereon. The electronic charm may be associated with, but not limited to, a phone number, a Uniform Resource Locator (URL), and an email address. The message may either be sent by the user of the electronic charm or a service, such as the manufacturer of the electronic charm. When the electronic device 102 detects the RFID of the electronic charm, an appropriate function, based on its association, can be performed by the electronic device 102.

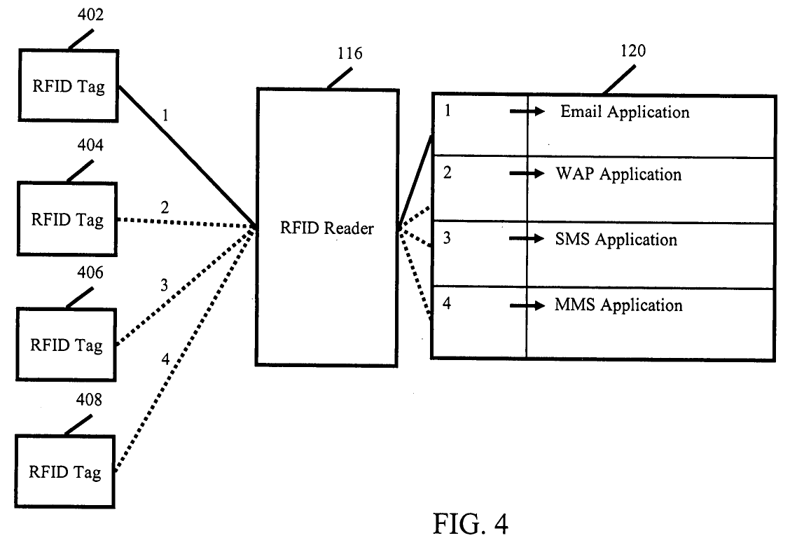

FIG. 4 is a block diagram illustrating the look-up table 120, in accordance with various embodiments of the present invention. The look-up table 120 includes one or more mappings between the RFID data and one or more applications. In one exemplary embodiment of the present invention, the RFID data can be a random number. For example, the RFID reader 116 may receive an RFID data signified by a random number ‘1’, stored in an RFID tag 402. Thereafter the RFID data is passed to the look-up table 120. The look-up table 120 identifies the mapping of the RFID data with the one or more applications. For example, as shown in FIG. 4, a mapping exists between the RFID data signified by the random number 1 and an email application. Similarly, a mapping exists between an RFID data signified by the random number ‘2’, stored in an RFID tag 404 and a WAP application; a mapping exists between an RFID data signified by the random number ‘3’, stored in an RFID tag 406 and an SMS application; and a mapping exists between an RFID data signified by the random number ‘4’, stored in an RFID tag 408 and an MMS application.

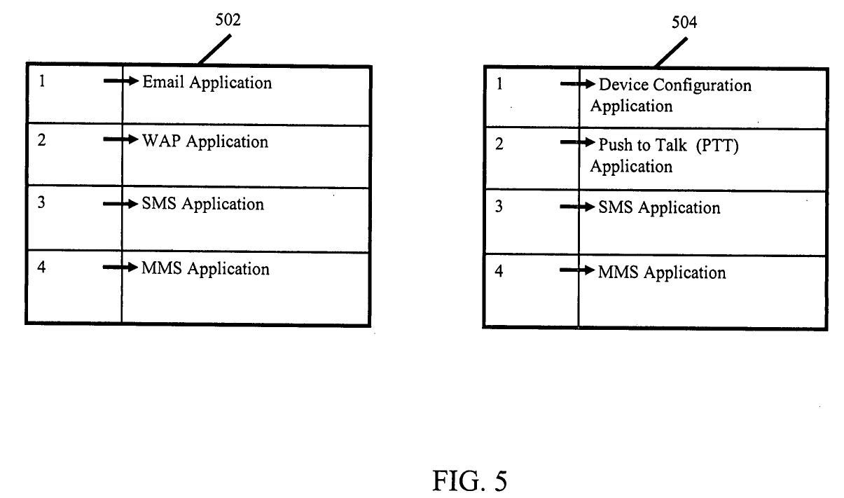

FIG. 5 illustrates an existing look-up table 502 and a modified look-up table 504, in accordance with various embodiments of the present invention. In the existing look-up table 502, a mapping exists between an RFID data signified by a random number ‘1’ and an email application, between an RFID data signified by a random number ‘2’ and a WAP application, between an RFID data signified by a random number ‘3’ and an SMS application, and between an RFID data signified by a random number ‘4’ and an MMS application. The existing look-up table 502 is modified to the modified look-up table 504, based on a first control message. In one exemplary embodiment of the present invention, the first control message includes the modified look-up table 504 that replaces the existing look-up table 502. In another exemplary embodiment of the present invention, the first control message includes information about the modification in the existing look-up table 502. The first control message is received from the network 110. The existing look-up table 502 may be modified, to map the RFID signified by the random number data 1 with an electronic device configuration application, and the RFID data signified by the random number 2 with a Push-to-Talk (PTT) application. Alternatively, the user of the electronic device 102 may modify the lookup table manually. (i.e. an editor allows the user to do the association) The electronic device 102 would read the RFID tag and if an association does not exist, the electronic device 102 would prompt the user to enter an association, or it may prompt the user to query a website.

Various embodiments of the present invention provide flexibility while using RFID tags for initiating/configuring various services, for example, location based services. The look-up table 120 present in the electronic device 102 can be modified any time by a first control message, received from a cellular service network. This implies that the RFID tags need not be replaced when a new service is to be associated with them.

Various embodiments of the present invention utilize RFID tags that are less expensive to manufacture. The RFID tags store random numbers, and various RFID tags with different random numbers can be associated with different services. Further, a range of numbers may be associated with an application. For example, numbers 10 to 50 may be associated with the launching of a particular website.

It will be appreciated the method and electronic device described herein may be comprised of one or more conventional processors and unique stored program instructions that control the one or more processors to implement, in conjunction with certain non-processor circuits, some, most, or all of the functions of the electronic device described herein. The non-processor circuits may include, but are not limited to, a radio receiver, a radio transmitter, signal drivers, clock circuits, power source circuits, and user input devices. As such, these functions may be interpreted as steps of a method to control the electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for controlling an electronic device, the electronic device including one or more applications, the method comprising:
receiving a first control message from a network;
receiving a second control message from a local device; and
executing a suitable application corresponding to the second control message, the suitable application being selected from the one or more applications using the first control message.

2. The method of claim 1, wherein the second control message is received from the local device over a local wireless link.

3. The method of claim 1, wherein the second control message is being sent using RFID technology.

4. The method of claim 1, wherein the first control message and the second control message are selected from a group consisting of a Short Message Service (SMS) message, a Multimedia Message Service (MMS) message, an Enhanced Message Service (EMS) message, an Electronic mail (E-mail), and an RFID data.

5. The method of claim 1, wherein the one or more applications are selected from a group consisting of a Short Message Service (SMS) application, a Multimedia Message Service (MMS) application, an Enhanced Message Service (EMS) application, an Electronic mail (E-mail) application, a Push-to-Talk (PTT) application, a telephony application, a web browsing application, and an electronic device configuration application.

6. A method for controlling an electronic device, the electronic device including one or more applications, the method comprising:
receiving a first control message from a network;
updating a look-up table according to the first control message;
receiving a Radio Frequency Identification (RFID) data from an RFID tag; and
executing a suitable application corresponding to the RFID data, the suitable application being selected from the one or more applications according to the look-up table.

7. The method of claim 6, wherein the first control message is received at the electronic device from a cellular service network.

8. The method of claim 6, wherein the look-up table comprises one or more mappings between the RFID data and the one or more applications.

9. The method of claim 6, wherein the look-up table is selected from a group consisting of an array, a link list, and a hash table.

10. The method of claim 6, wherein updating the look-up table comprises adding an entry into the look-up table.

11. The method of claim 6, wherein updating the look-up table comprises modifying an existing entry into the look-up table.

12. An electronic device comprising:
a Radio Frequency Identification (RFID) reader capable of reading RFID data from an RFID tag;
a look-up table including one or more mappings between the RFID data and one or more applications present in the electronic device, the look-up table being capable of modification by a first control message sent from a network; and
an application selecting module for executing a suitable application upon receiving the RFID data, the suitable application being selected from the one or more applications using the look-up table.

13. The electronic device of claim 12 wherein the electronic device is selected from a group consisting of a mobile phone, a personal digital assistant (PDA), and a laptop.
